(19) United States
(12) Patent Application Publication
(10) Pub. No.: US 2026/0369790 A1
(43) Pub. Date: Nov. 19, 2026

(54) BATTERY APPARATUS AND ELECTRICAL DEVICE

(71) Applicant: CONTEMPORARY AMPEREX TECHNOLOGY CO., LIMITED, Ningde (CN)

(72) Inventors: Jun LIU, Ningde (CN); Jun MA, Ningde (CN); Yuanbo TAN, Ningde (CN); Zhiming CHEN, Ningde (CN); Cancan LI, Ningde (CN); Jiangming LIU, Ningde (CN)

(21) Appl. No.: 19/343,473

(22) Filed: Sep. 29, 2025

Related U.S. Application Data
(63) Continuation of application No. PCT/CN2025/105996, filed on Jun. 30, 2025.

(30) Foreign Application Priority Data
May 16, 2025 (CN) 202510637381.2

(51) Int. Cl. H01M 50/264; H01M 50/209; H01M 50/242; H01M 50/249

(52) U.S. Cl. CPC H01M 50/264; H01M 50/209; H01M 50/242; H01M 50/249; H01M 2220/20

(57) ABSTRACT

A battery apparatus comprises a box body having an accommodating cavity and a first wall arranged on one side of the accommodating cavity, a battery cell arranged in the accommodating cavity and supported on the first wall, and a position-limiting member arranged in the accommodating cavity. A fixing member is arranged on the first wall and in the accommodating cavity, and is located on a side of the battery cell along a first direction intersecting an arrangement direction of the battery cell and the first wall. The fixing member and the first wall are of an integral structure. Along the arrangement direction of the battery cell and the first wall, the position-limiting member is connected to an end of the fixing member away from the first wall and is pressed against an end of the battery cell away from the first wall.

### CROSS-REFERENCE TO RELATED APPLICATIONS

The present application is a continuation of International Application No. PCT/CN2025/105996, filed on Jun. 30, 2025, which claims priority to Chinese patent application 202510637381.2 filed on May 16, 2025 and entitled “BATTERY APPARATUS AND ELECTRICAL DEVICE”, which are incorporated herein by reference in their entirety.

### TECHNICAL FIELD

The present application relates to the technical field of batteries, and in particular, to a battery apparatus and an electrical device.

### BACKGROUND

This section provides merely background information relevant to the present application, and is not necessarily prior art.

As the demand for clean energy rises, battery apparatuses have been widely developed. Battery apparatuses can store and release electric energy efficiently, and their performance and structural design are crucial to the operating efficiency and reliability of electrical devices.

How to improve the reliability of battery apparatuses has always been the focus of attention in the research and development process.

### SUMMARY

In view of the above problems, the present application provides a battery apparatus and an electrical device to at least improve the reliability of the battery apparatuses.

The first aspect of the present application proposes a battery apparatus and an electrical device, the battery apparatus comprises a battery cell, a box body and a position-limiting member, the box body has an accommodating cavity and a first wall, the first wall is arranged on one side of the accommodating cavity, the battery cell is arranged in the accommodating cavity and supported on the first wall, a fixing member is arranged on the first wall, the fixing member and the first wall are of an integral structure, the fixing member is arranged in the accommodating cavity and is located on a side of the battery cell along a first direction, and the first direction intersects with the arrangement direction of the battery cell and the first wall; the position-limiting member is arranged in the accommodating cavity, and along the arrangement direction of the battery cell and the first wall, the position-limiting member is connected to an end of the fixing member away from the first wall and is pressed against an end of the battery cell away from the first wall.

In the technical solution of the embodiment of the present application, the fixing member and the first wall are of an integral structure with high connection stability and strength, and the fixing member can limit the position of the battery cell in the first direction; the battery cell is supported on the first wall, and the position-limiting member is connected to the fixing member integrally arranged on the first wall, the position-limiting member is pressed against an end of the battery cell away from the first wall, and the battery cell can be pressed against and fixed on the first wall, which improves the assembly convenience of the battery cell and the fixing stability of the battery cell in the box body, reduces the possibility of failure of the connection between the battery cell and the box body, and improves the reliability of the battery apparatus.

In addition, the battery apparatus according to the present application may further have the following additional technical features.

In some embodiments of the present application, the fixing member and the first wall are of an integrally formed structure. The fixing member and the first wall are of an integrally formed structure, and the connection strength between the fixing member and the first wall is relatively high, which can effectively reduce the problem of fixing failure caused by loosening or damage at the connection point. At the same time, the integrally formed structure can also improve production efficiency, reduce the number of parts and components, and reduce production costs.

In some embodiments of the present application, the fixing member and the first wall are of a structure formed by integral profile extrusion. The first wall and the fixing member are formed by integral profile extrusion. This design features easy processing and can achieve close connection and seamless combination of the two, which provides good integrity and connection strength, and can reduce the risk of failure caused by improper connection. At the same time, the fixing member and the first wall themselves and the connection position between the two have good flatness, which is conducive to improving the assembly stability of the battery cell.

In some embodiments of the present application, the fixing member and the position-limiting member are provided as an integral structure. The fixing member and the position-limiting member are of an integral structure, which can improve the connection strength between the fixing member and the position-limiting member, can effectively reduce the problem of fixing failure caused by loosening or damage at the connection point, and improve the reliability of the battery apparatus.

In some embodiments of the present application, the fixing member and the position-limiting member are assembled and connected as separate components. By assembling and connecting the fixing member and the position-limiting member as separate components, during the assembly of the battery apparatus, the battery cell can be first lowered from an end (upper end) of the fixing member away from the first wall onto the first wall, and then the position-limiting member can be assembled on the fixing member to make the position-limiting member to press against the battery cell. The method of assembling the position-limiting member later can facilitate the lowering of the battery cells into the box body, reduce the interference of the components to the battery cell, and improve the assembly efficiency of the battery cell.

In some embodiments of the present application, the fixing member is welded to the position-limiting member. The fixing member is welded to the position-limiting member, which can provide higher strength, reduce the number of connecting members, and reduce the possibility of mutual interference between the members.

In some embodiments of the present application, the battery cell comprises a case, an end of the case away from the first wall is a first end portion, the position-limiting member is pressed against the end face of the first end portion, an end of the fixing member away from the first wall is a second end portion, the position-limiting member is connected to the end face of the second end portion, and along the arrangement direction of the battery cell and the first wall, the end face of the first end portion is flush with the end face of the second end portion or the end face of the first end portion is closer to the first wall than the end face of the second end portion. The end face of the second end portion is farther away from the first wall than the end face of the first end portion, so that the fixing member can be higher than or flush with the case of the battery cell. When the position-limiting member and the fixing member are assembled and connected, they are not easily interfered by the battery cell, which improves the assembly convenience between the position-limiting member and the fixing member.

In some embodiments of the present application, the position-limiting member has a connecting portion, the connecting portion is arranged corresponding to the end face of the second end portion, and the fixing member is connected to the end face of the second end portion through the connecting portion. By providing a connecting portion corresponding to the end face of the second end portion, the connecting portion is located on the end face of the second end portion, which facilitates the connection between the fixing member and the position-limiting member and reduces the possibility of interference between the connection position of the fixing member and the position-limiting member and the battery cell.

In some embodiments of the present application, the fixing member and the position-limiting member extend along a second direction, the position-limiting member has a plurality of connecting portions spaced apart along the second direction, and the first direction, the second direction, and the arrangement direction of the battery cell and the first wall intersect with each other. The position-limiting member is provided with a plurality of connecting portions spaced apart, which can improve the connection stability between the fixing member and the position-limiting member; when the connecting portions are provided for welding, the connecting portions are provided in a dispersed manner, and the welding convenience and welding reliability are better.

In some embodiments of the present application, at least one said position-limiting member is a first position-limiting member, the connecting portion is a welding hole, the first position-limiting member is welded and connected to the corresponding fixing member through the welding hole, the two hole walls of the welding hole opposite to each other in the first direction are first hole walls, and the two first hole walls are inclined away from each other from an end facing the fixing member to an end away from the fixing member. The connecting portion is arranged as a welding hole, which facilitates welding of the first position-limiting member to the corresponding fixing member. The welding hole is arranged in a form in which the first hole wall is inclined, and an end of the welding hole close to the fixing member is narrower, while an end away from the fixing member is wider, so that during the welding process, the interference and shielding of the first hole wall to the welding position is reduced, the convenience of the welding operation is improved, which is conducive to improving the welding quality and reducing the possibility of false welding.

In some embodiments of the present application, the angle between the two first hole walls is 20° to 80°; and/or, along the arrangement direction of the battery cell and the first wall, the depth of the welding hole is greater than or equal to the thickness of the first position-limiting member; and/or, the maximum width of the welding hole along the first direction is less than or equal to the thickness of the first position-limiting member along the arrangement direction of the battery cell and the first wall. By setting the angle between the two first hole walls to 20° to 80°, the interference and shielding of the first hole walls to the welding position is reduced during the welding process, which improves the convenience of welding operation, helps to improve welding quality, and reduces the possibility of false welding. By making the depth of the welding hole greater than or equal to the thickness of the first position-limiting member, the connection strength between the first position-limiting member and the fixing member welded through the welding hole can be improved. By designing the welding hole to have a maximum width along the first direction that is less than or equal to the thickness of the first position-limiting member, the connection strength between the first position-limiting member and the fixing member through the welding hole can be improved, and the influence of the welding hole on the strength of the fixing member can be reduced.

In some embodiments of the present application, along the first direction, the first position-limiting member is arranged between two adjacent battery cells, and both sides of the first position-limiting member protrude relative to the fixing member to form first pressing portions, and the first pressing portions on both sides of the first position-limiting member are respectively pressed against the two adjacent battery cells. The first position-limiting member can be arranged between two rows of battery cells. By arranging a fixing member and a first position-limiting member connected thereto, the battery cells on both sides can be pressed and fixed. The structure is simple, the space occupied by the fixing member and the manufacturing cost can be reduced, and the energy density of the battery apparatus can be improved.

In some embodiments of the present application, at least one said position-limiting members is a second position-limiting member, along the first direction, one side of the second position-limiting member protrudes relative to the fixing member to form a second pressing portion, a welding protrusion is provided on the other side of the second position-limiting member opposite to the second pressing portion, the second pressing portion of the second position-limiting member is pressed against and matched with the battery cell, the welding protrusion is the connecting portion, and the second position-limiting member is welded to the fixing member through the welding protrusion. Along the first direction, the second position-limiting member is provided with a second pressing portion on the side facing the battery cell, and the side opposite to the battery cell is welded to the fixing member through the welding protrusion. The structure is simple and the welding operation is convenient. Moreover, the connecting portion is set as a welding protrusion, which is not easy to affect the strength of the second position-limiting member.

In some embodiments of the present application, an electrode terminal is provided on a side of the battery cell away from the first wall, and along the first direction, the position-limiting member is located on one side of the electrode terminal and is spaced apart from the electrode terminal. The position-limiting member is located on one side of the electrode terminal and is spaced apart from the electrode terminal, which can reduce the interference of the position-limiting member to the electrode terminal, reduce the possibility of short circuit of the battery cell, and improve the reliability of the battery apparatus.

In some embodiments of the present application, a first buffer member is provided between the fixing member and the battery cell. The first buffer member can play a buffering and protective role, reduce the possibility of the battery cell being damaged by the position-limiting member, and improve the reliability of the battery apparatus.

In some embodiments of the present application, the first buffer member is configured as an insulating structure. The first buffer member is configured as an insulating structure, which can reduce the possibility of short circuit caused by electrical connection between the battery cell and the position-limiting member, thereby improving the reliability of the battery apparatus.

In some embodiments of the present application, the battery cell comprises a case and an electrode terminal, an end of the case away from the first wall is a first end portion, the electrode terminal is located at the first end portion, the position-limiting member is pressed against the first end portion, the first buffer member comprises a first part and a second part, the first part is arranged between the position-limiting member and the electrode terminal, and the second part is arranged between the position-limiting member and the first end portion. The first part can reduce the possibility of the position-limiting member damaging the electrode terminal, and the second part can reduce the possibility of the position-limiting member damaging the case, thereby improving the reliability of the battery apparatus.

In some embodiments of the present application, a second buffer member is provided between the fixing member and the battery cell. The second buffer member can play a buffering and protective role, reduce the possibility of the battery cell being damaged by the fixing member, and improve the reliability of the battery apparatus.

In some embodiments of the present application, the second buffer member comprises a first sub-buffer member, the first sub-buffer member is arranged between an end of the fixing member facing the position-limiting member and the battery cell, the first buffer member is arranged between the position-limiting member and the battery cell, and the first buffer member and the first sub-buffer member are of an integral structure. The first buffer member and the first sub-buffer member are connected into a whole, and the two can be placed on the shoulder of the battery cell simultaneously to protect the shoulder of the battery cell, thereby improving the convenience of operation and the protection performance.

In some embodiments of the present application, a third buffer member is provided between the first wall and the battery cell. The third buffer member can play a buffering and protective role, reduce the possibility of the battery cell being damaged by the first wall, and improve the reliability of the battery apparatus.

In some embodiments of the present application, a second buffer member is provided between the fixing member and the battery cell, the second buffer member comprises a second sub-buffer member, the second sub-buffer member is arranged between an end of the fixing member away from the position-limiting member and the battery cell, and the second sub-buffer member and the third buffer member are of an integral structure. The second sub-buffer member and the third buffer member are of an integral structure, and the two can be placed on the bottom shoulder of the battery cell simultaneously to protect the shoulder of the battery cell, thereby improving the convenience of operation and the protection performance.

In some embodiments of the present application, a flow channel for a heat exchange medium to flow is provided in the first wall; and/or a flow channel for a heat exchange medium to flow is provided in the fixing member; and/or a flow channel for a heat exchange medium to flow is provided in the position-limiting member. By arranging flow channels in the first wall, the fixing member and/or the position-limiting member, the heat exchange medium flowing through the flow channels can exchange heat with the battery cells, thereby adjusting the temperature of the battery cells, realizing a thermal pipeline for the battery apparatus, and improving the reliability of the battery apparatus.

In some embodiments of the present application, a thermally conductive structure is provided between the first wall and the battery cell; and/or, a thermally conductive structure is provided between the fixing member and the battery cell; and/or, a thermally conductive structure is provided between the position-limiting member and the battery cell. By providing a thermally conductive structure, the thermal conduction efficiency of the battery cell can be improved, the temperature regulation capability of the battery cell can be improved, and the reliability of the battery apparatus can be improved.

In some embodiments of the present application, along a second direction, the box body has a second wall and a third wall that are opposite to each other, the second wall and the third wall are respectively connected to the first wall and both enclose the accommodating cavity, along the second direction, the two ends of the position-limiting member are respectively connected to the second wall and the third wall, and/or the two ends of the fixing member are respectively connected to the second wall and the third wall, and the first direction, the second direction and the arrangement direction of the battery cell and the first wall intersect with each other. The position-limiting member and/or the fixing member are connected to the second wall and the third wall of the box body, which can improve the overall rigidity of the box body, improve the fixing effect on the battery cell, and increase the resistance of the box body to expansion force.

In some embodiments of the present application, a plurality of battery cells are arranged, and the plurality of battery cells are arranged in at least one row, each row includes a plurality of battery cells arranged along a second direction, the position-limiting member and the fixing member extend along the second direction, the position-limiting member is pressed against the plurality of battery cells in the same row adjacent thereto, and the first direction, the second direction and the arrangement direction of the battery cell and the first wall intersect with each other. The position-limiting member extends along the arrangement direction of the battery cells in the same row and can be pressed against a plurality of battery cells at the same time. It has a simple structure and is convenient to arrange, which is conducive to improving assembly efficiency.

In some embodiments of the present application, along the second direction, the position-limiting member is provided with an avoidance slot, the avoidance slot is configured to allow at least one of the battery cells to pass through, and the battery cell is configured to be able to slide relative to the position-limiting member and the fixing member along the second direction. When assembling the battery apparatus, the battery cells can be assembled in the box body after the position-limiting member and the fixing member are assembled. The assembly time and assembly method of the position-limiting member and the fixing member are more flexible.

In some embodiments of the present application, a heating member is provided on the fixing member and/or the limiting member. By providing a heating member, the battery cell can be heated to improve the thermal management performance of the battery apparatus.

In some embodiments of the present application, the first wall is the bottom wall of the box body.

In some embodiments of the present application, along a second direction, the box body has a second wall and a third wall that are opposite to each other, the second wall and the third wall are respectively connected to the first wall and both enclose the accommodating cavity, and the second wall, the third wall and the first wall are of an integrally formed structure.

The second aspect of the present application proposes an electrical device, which comprises the battery apparatus proposed in the present application or any embodiment of the present application. The battery apparatus is used for storing electric energy or providing electric energy.

The electrical device according to the present application has the same beneficial effects as the battery apparatus proposed in the present application or any embodiment of the present application.

The foregoing descriptions are merely an overview of the technical solutions in the present application. In order that technical means of the present application can be understood more clearly so that the technical solutions can be implemented according to content of the descriptions, and in order that the foregoing and other objectives, features, and advantages of the present application can be understood more clearly, specific embodiments of the present application are described below.

### DESCRIPTION OF DRAWINGS

By reading the detailed description of the embodiments below, various other advantages and benefits will become apparent to those of ordinary skill in the art. The drawings are used for the purpose of illustrating some embodiments only and are not to be considered a limitation to the present application. Moreover, throughout the accompanying drawings, the same components are indicated by the same reference numerals. In the drawings:

FIG. 1 is a schematic structural view of a vehicle according to some embodiments of the present application;

FIG. 2 is a schematic structural diagram of a battery apparatus according to some embodiments of the present application;

FIG. 3 is an exploded schematic diagram of a battery cell according to some embodiments of the present application;

FIG. 4 is an exploded schematic diagram of some components of a battery apparatus according to some embodiments of the present application;

FIG. 5 is a section view of assembly of some components of a battery apparatus according to some embodiments of the present application;

FIG. 6 is an enlarged view of portion A in FIG. 5;

FIG. 7 is an enlarged view of portion D in FIG. 6;

FIG. 8 is an enlarged view of portion C in FIG. 1;

FIG. 9 is a schematic partial section view of a battery apparatus according to some embodiments of the present application;

FIG. 10 is a partial structural diagram of a battery apparatus according to some embodiments of the present application;

FIG. 11 is an enlarged diagram of portion B in FIG. 10.

### REFERENCE NUMERALS

1000, Vehicle; 10, Battery apparatus; 20, Controller; 30, Motor;

100, Box body; 101, First box body; 102, Second box body; 103, Accommodating cavity; 104, First wall; 105, Second wall; 106, Third wall; 110, Fixing member; 111, Second end portion; 120, Position-limiting member; 1201, Connecting portion; 121, First position-limiting member; 1211, Welding hole; 1212, First hole wall; 1213, First pressing portion; 122, Second position-limiting member; 1221, Welding protrusion; 1222, Second pressing portion; 130, First buffer member; 131, First part; 132, Second part; 140, Second buffer member; 141, First sub-buffer member; 142, Second sub-buffer member; 150, Third buffer member; 160, Flow channel; 170, Thermally conductive structure; 180, Avoidance slot; 190, Rivet nut;

200, Battery cell assembly; 210, Battery cell; 211, Electrode assembly; 212, Shell; 213, Case; 214, End cover; 215, Tab; 216, Electrode terminal; 217, First end portion;

X. First direction; Y. Second direction; Z. Arrangement direction.

### DETAILED DESCRIPTION

The embodiments of the technical solutions of the present application will be described in detail below with reference to the accompanying drawings. The following embodiments are only used to more clearly illustrate the technical solutions of the present application, therefore only as examples, and cannot be used to limit the scope of protection of the present application.

Unless otherwise defined, all technical and scientific terms used herein have the same meanings as those commonly understood by those skilled in the art to which the present application pertains to. The terms used herein are for the purpose of describing specific embodiments only and are not intended to limit the present application. The terms “including” and “having” and any variations thereof in the specification and claims of the present application and the aforementioned BRIEF DESCRIPTION OF DRAWINGS are intended to cover non-exclusive inclusion.

In the description of the embodiments of the present application, the technical terms “first”, “second”, etc., are only used for distinguishing different objects, and cannot be understood as indicating or implying relative importance or implying the number, specific order or primary and secondary relationship of the technical features indicated. In the description of the embodiments of the present application, the meaning of “a plurality of” is two or more, unless otherwise explicitly and specifically defined.

Reference to “an embodiment” herein means that a particular feature, structure, or characteristic described with reference to an embodiment can be included in at least one embodiment of the present application. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

In the description of the embodiment of the present application, the term “and/or” is merely an association that describes the associated object, indicating that there can be three kinds of relationships, such as A and/or B, which can be denoted as: the existence of A alone, the existence of A and B at the same time, and the existence of B alone. Moreover, the character “/” herein generally indicates that the context objects are in an “or” relationship.

In the description of the embodiments of the present application, the term “a plurality of” refers to more than two (including two), and similarly, “a plurality of groups” refers to more than two groups (including two groups); and “a plurality of sheets” refers to more than two sheets (including two sheets).

In the description of the embodiments of the present application, the orientation or positional relationships indicated by the technical terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or positional relationships shown in the accompanying drawings, and are only for convenience of description of the present application and simplification of the description, rather than indicating or implying that the indicated apparatus or element must have a specific orientation, be constructed and operate in a specific orientation, and therefore, cannot be understood as a limitation to the present application.

In the description of the embodiments of the present application, unless otherwise expressly specified and limited, the technical terms “mount,” “connect,” “connection,” “fix”, etc. should be understood in a broad sense, such as, a fixed connection, a detachable connection, or an integral connection; a mechanical connection, or an electrical connection; directly connect, indirectly connect through an intermediate medium, an internal communication of two elements, or interaction between two elements. To those of ordinarily skill in the art, the specific meanings of the above terms in the embodiments of the present application may be understood according to specific circumstances.

Against the backdrop of rising demand for clean energy, battery apparatuses are widely used in electronic devices, electric vehicles, power tools and other fields. The performance of battery apparatuses is directly related to the operating efficiency and reliability of electrical devices. The battery apparatus may include a box body and battery cells, and the battery cells may be arranged in groups. Research has found that in existing battery apparatuses, there are many problems with the way battery cells are fixed and grouped, which affects the reliability and stability of the battery apparatuses.

First, traditional battery cells usually rely on structural adhesive to bond the battery cells to the box body to achieve connection into groups. The general process is as follows: structural adhesive is coated on the bottom of the box body, the battery cells are placed in the box body in a vertical direction, and fixed to the box body by structural adhesive to achieve grouping. This fixing method will significantly increase the weight of the battery apparatus, thereby reducing the energy density of the battery apparatus and affecting its overall performance. Secondly, the bonding performance of the structural adhesive is extremely demanding, and high-strength adhesives need to be used, which undoubtedly increases the manufacturing cost of the battery apparatus. In addition, the adhesive coating areas of the battery cells and the box body need to achieve a high degree of flatness and cleanliness, and the adhesive coating process also requires complex steps such as standing and baking, further increasing the manufacturing cost. More importantly, the strength of structural adhesive is easily affected by the temperature and humidity during the process and the external loads during vehicle operation, which can easily lead to debonding problems and affect the stability and reliability of the battery apparatus.

In order to solve the above problems, a battery apparatus is proposed, where the traditional structural adhesive fixing effect is replaced or reduced by mechanical fixing, that is, through the coordinated effect of the fixing member and the position-limiting member, the reliable fixation of the battery cell is achieved. For the battery apparatus of the present application, a fixing member is integrally arranged on the bottom wall of the box body, and a position-limiting member is connected to an end of the fixing member away from the first wall and pressed against the top end of the battery cell.

The battery apparatus of the present application can significantly improve the reliability and stability of the battery apparatus. The fixing member and the bottom wall of the box body are of an integral structure, providing a high-strength connection. The fixing member can provide a limiting effect for the battery cell, thereby improving the convenience of grouping the battery cells. For the battery apparatus of the present application, the position-limiting member is connected to the fixing member, and the position-limiting member is pressed against the top end of the battery cell. The position-limiting member connected to the fixing member has a pressing and limiting effect on the battery cell, so that the battery cell can be fixed, and during the grouping and assembly process of the battery cell, the battery cell and the first wall are kept relatively fixed, so that the battery cell can be smoothly grouped, and the use of structural adhesive can be reduced or eliminated, thereby reducing the extra weight added by the structural adhesive, improving the energy density of the battery apparatus, and at the same time, reducing the dependence on high-precision adhesive coating devices and complex process flow, thereby reducing the manufacturing cost. Also, for the battery apparatus of the present application, the battery cell is fixed by the combination of the fixing member and the position-limiting member. This fixing method is not easily affected by the temperature and humidity in the process and the external load during the operation of the electrical device, thereby reducing the possibility of connection failure of the battery cell due to debonding, reducing the shaking of the battery cell in the box body, and reducing the risk of wear and damage between the battery cells and between the battery cell and the box body due to collision.

The battery apparatus disclosed in the embodiments of the present application is suitable for various electrical devices using the battery apparatus, and the power supply system of the electrical device can be composed of the battery apparatus disclosed in the present application. The electrical device may be mobile phones, portable devices, laptops, battery cars, electric toys, electric tools, vehicles, ships and spacecraft, etc. The electric toy may include a stationary or mobile electric toy, for example, a game console, an electric car toy, an electric ship toy, and an electric aircraft toy, and the like, and the spacecraft may include an aircraft, a rocket, a space shuttle and a spaceship, and the like.

The following embodiments, for the convenience of illustration, take the vehicle being an electrical device in one embodiment of the present application as an example to illustrate.

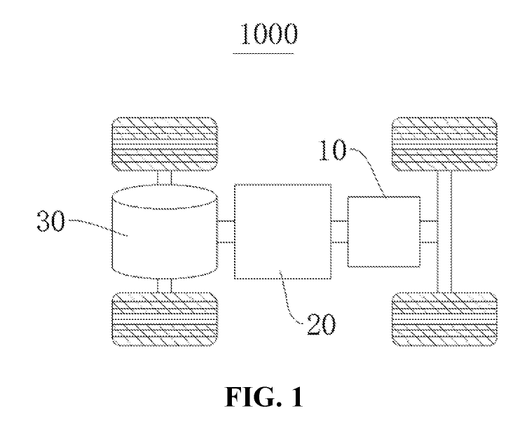

Referring to FIG. 1, FIG. 1 is a structural schematic view of a vehicle provided in some embodiments of the present application. The vehicle 1000 may be a fuel vehicle, a gas vehicle, or a new energy vehicle. The new energy vehicle may be an all-electric vehicle, a hybrid vehicle, an extended-range vehicle, or the like. A battery apparatus 10 is arranged in the vehicle 1000. The battery apparatus 10 may be arranged at the bottom, or head, or tail of the vehicle 1000. The battery apparatus 10 may be configured to supply power to the vehicle 1000. For example, the battery apparatus 10 may be used as an operating power source of the vehicle 1000. The vehicle 1000 may further include a controller 20 and a motor 30. The controller 20 is configured to control the battery apparatus 10 to supply power to the motor 30, for example, for the operation power demand for starting, navigation and driving of the vehicle 1000.

In some embodiments of the present application, the battery apparatus 10 may not only be used as an operating power source for the vehicle 1000, but also as a driving power source for the vehicle 1000, to replace or partially replace fuel or natural gas to provide driving power for the vehicle 1000.

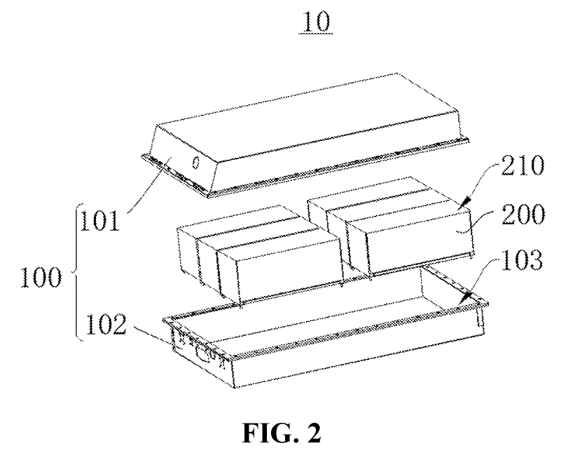

As shown in FIG. 2, FIG. 2 is a schematic structural diagram of a battery apparatus according to some embodiments of the present application. The battery apparatus 10 mentioned in the embodiments of the present application may comprise one or more battery cell assemblies 200 for providing voltage and capacity. The battery cell assembly 200 may comprise one or more battery cells 210, and a plurality of battery cells 210 are connected by series connection, or parallel connection, or parallel-series connection through a busbar component.

In some embodiments, a battery cell assembly 200 is generally formed by arranging a plurality of battery cells 210.

As an example, the battery cell assembly 200 can be a battery module, and the battery module is composed of a plurality of battery cells 210 arranged and fixed to form an independent module. As an example, the battery module may be formed by bundling a plurality of battery cells 210 with cable ties.

In some embodiments, the battery apparatus 10 may be a battery pack. The battery pack comprises a box body 100 and one or more battery cell assemblies 200. The battery cell assembly 200 is accommodated in the box body 100.

As an example, the battery cell assembly 200 may be a battery module, and the battery cell assembly 200 may be accommodated in the box body 100 by fixing the battery module in the box body 100.

As an example, the battery cell assembly 200 may also be accommodated in the box body 100 by directly fixing the plurality of battery cells 210 to the box body 100.

As an example, the box body 100 may include a first box body 101 and a second box body 102. The first box body 101 and the second box body 102 are fastened together to form an enclosure space inside the box body 100 to accommodate the battery cell assembly 200. Enclosure here means covering or closing, and may be sealed or unsealed. The first box body 101 may be a top cover or a bottom plate.

As an example, the box body 100 may include a top cover, a frame, and a bottom plate. The top cover and the bottom plate are respectively connected to the frame, so that an enclosure space is formed inside the box body 100 to accommodate the battery cell assembly 200.

In some embodiments, the box body 100 may be a part of a vehicle chassis structure 1000. For example, a portion of the box body 100 may become at least a portion of the floor of the vehicle 1000, or a portion of the box body 100 may become at least a portion of the cross beam and the longitudinal beam of the vehicle 1000.

In some embodiments, the battery apparatus 10 refers to an energy storage device, which includes a cabinet having a door on at least one side thereof. The energy storage apparatus comprises an energy storage container, an energy storage cabinet, or the like.

In the embodiments of the present application, the battery cell 210 may be a secondary battery. The secondary battery refers to a battery cell 210 that, after the battery cell 210 is discharged, can activate an active material by charging for continued use.

The battery cell 210 may be a lithium-ion battery, a sodium-ion battery, a sodium/lithium-ion battery, a lithium metal battery, a sodium metal battery, a lithium-sulfur battery, a magnesium-ion battery, a nickel-hydrogen battery, a nickel-cadmium battery, a lead storage battery, or the like, which is not limited in the embodiments of the present application.

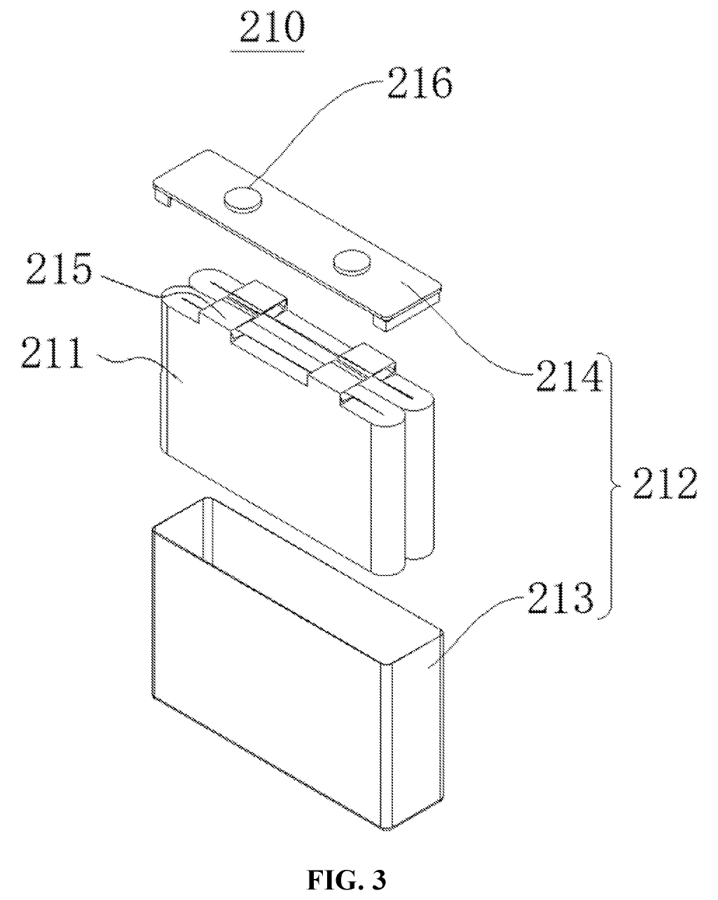

As shown in FIG. 3, FIG. 3 is an exploded schematic diagram of a battery cell according to some embodiments of the present application, and the battery cell 210 generally comprises an electrode assembly 211. The electrode assembly 211 comprises a positive electrode, a negative electrode, and a separator, and the separator is arranged between the negative electrode and the positive electrode. During the charging and discharging of the battery cell 210, active ions (such as lithium ions) are intercalated and deintercalated back and forth between the positive electrode and the negative electrode. The separator is arranged between the positive electrode and the negative electrode, and mainly functions to prevent a short circuit between the positive electrode and the negative electrode while enabling active ions to pass through.

In some embodiments, the electrode assembly 211 is provided with tabs 215, and the tabs 215 can conduct current out of the electrode assembly 211. The tabs 215 include a positive tab 215 and a negative tab 215.

In some embodiments, the tab 215 may be connected to an electrode terminal 216, and the electrode terminal 216 is electrically connected to the tab 215 to achieve connection and current transmission between the electrode assembly 211 and an external circuit. The electrode terminal 216 can be directly connected to the tab 215, or can also be indirectly connected to the tab 215 through a current collecting member.

In some embodiments, the battery cell 210 may comprise a shell 212. The shell 212 may be a steel shell, an aluminum shell, a plastic shell (such as polypropylene), a composite metal shell (such as a copper-aluminum composite shell 212), an aluminum-plastic film, or the like. In some embodiments, the shell 212 may be a sealed structure or a non-sealed structure. As an example, when the shell 212 is a non-sealed structure, the shell 212 can protect the electrode assembly 211. A sealing bag is also included between the shell 212 and the electrode assembly 211, and the sealing bag is used to encapsulate the electrode assembly 211 and the electrolyte. Specifically, the sealing bag may be a bag-shaped insulating structure or an aluminum-plastic film. When the shell 212 is a sealed structure, it is used to encapsulate components such as the electrode assembly 211 and the electrolyte.

As an example, the battery cell 210 may be a cylindrical battery cell 210, a prismatic battery cell 210, a pouch battery cell 210, or a battery cell 210 of other shapes. The prismatic battery cell 210 includes a square battery cell 210, a blade-shaped battery cell 210, and a multi-prism battery cell 120. The multi-prism battery cell 120 is, for example, a hexagonal prism battery cell 120, etc., which is not particularly limited in the present application.

In some embodiments, the shell 212 comprises an end cover 214 and a case 213, the case 213 has an opening, and the end cover 214 covers the opening. The case 213 may be provided with one or more openings. One or more end covers 214 may also be provided.

In some embodiments, the shell 212 is provided with at least one electrode terminal 216, and the electrode terminal 216 is electrically connected to a tab 215. The electrode terminal 216 can be directly connected to the tab 215 or can also be indirectly connected to the tab 215 through a current collecting member. The electrode terminal 216 may be arranged on the end cover 214, or may also be arranged on the case 213.

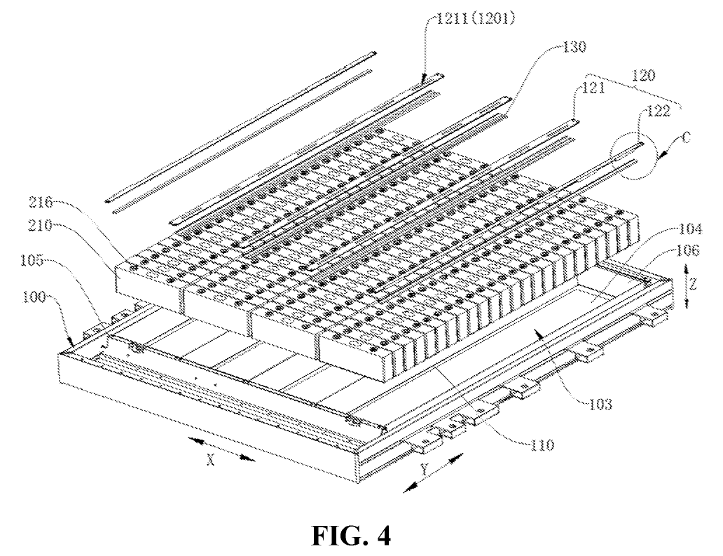

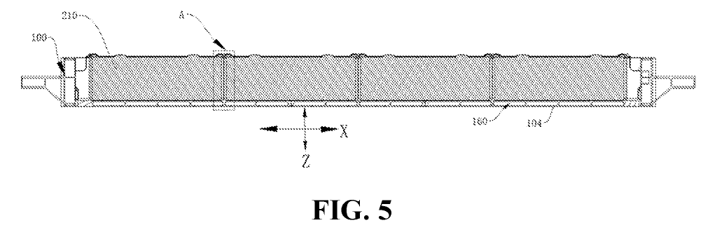

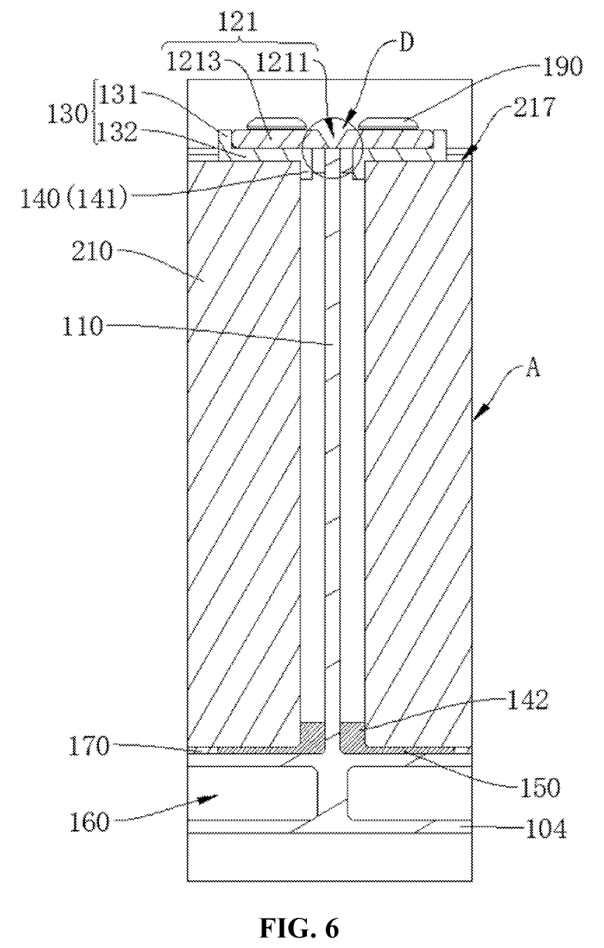

Referring to FIGS. 2-3 and in combination with FIGS. 4-6, FIG. 4 is an exploded schematic diagram of some components of a battery apparatus according to some embodiments of the present application, FIG. 5 is a cross-sectional view of assembly of some components of the battery apparatus according to some embodiments of the present application, and FIG. 6 is an enlarged view of portion A of FIG. 5. The present application provides a battery apparatus 10 comprising a battery cell 210, a box body 100 and a position-limiting member 120, the box body 100 has an accommodating cavity 103 and a first wall 104, the first wall 104 is arranged on one side of the accommodating cavity 103, the battery cell 210 is arranged in the accommodating cavity 103 and supported on the first wall 104, a fixing member 110 is arranged on the first wall 104, the fixing member 110 and the first wall 104 are of an integral structure, the fixing member 110 is arranged in the accommodating cavity 103 and is located on a side of the battery cell 210 along the first direction X, and the first direction X intersects with the arrangement direction Z of the battery cell 210 and the first wall 104; the position-limiting member 120 is arranged in the accommodating cavity 103, and along the arrangement direction Z of the battery cell 210 and the first wall 104, the position-limiting member 120 is connected to an end of the fixing member 110 away from the first wall 104 and is pressed against an end of the battery cell 210 away from the first wall 104.

The accommodating cavity 103 is a space enclosed by the box body 100 and is used to accommodate the battery cells 210.

The first wall 104 is a wall of the box body 100 enclosing the accommodating cavity 103, that is, a portion of the wall of the box body 100 surrounding the battery cell 210. The first wall 104 can provide support for the battery cell 210 at least during the process of assembling the battery cell 210 into the box body 100. That is, at least during the process of assembling the battery cell 210 into the box body 100, the first wall 104 is arranged below the battery cell 210 and supports the battery cell 210.

Exemplarily, the first wall 104 may be the bottom wall of the box body 100, and the battery cells 210 are arranged on the first wall 104 and supported by the first wall 104. The bottom wall of the box body 100 refers to the portion of the box body 100 enclosing the bottom of the accommodating cavity 103, which is a reference description when the battery apparatus 10 is in a normal use state.

Optionally, in some other embodiments, the first wall 104 may also be a side wall or top wall of the box body 100. The side wall or top wall of the box body 100 is described for reference based on the battery apparatus 10 being in a normal use state.

The fixing member 110 is arranged on a side of the first wall 104 facing the accommodating cavity 103. The fixing member 110 and the first wall 104 are of an integral structure, which can be understood as the fixing member 110 and the first wall 104 being integrally arranged.

It should be noted that being integrally arranged or an integral structure refers to two components forming a continuous, indivisible whole structure, wherein indivisible means that a structure cannot be separated into two parts without destroying the structure or the connection. The methods for achieving being integrally arranged or an integral structure include integral forming (such as injection molding, extrusion molding, 3D printing), fusion connection (such as welding, fusion), etc.

Exemplarily, the fixing member 110 and the first wall 104 may be processed separately and then assembled into an integral structure. For example, the fixing member 110 and the first wall 104 may be welded to form an integral structure.

For example, the fixing member 110 and the first wall 104 may also be of an integrally formed structure. For example, the fixing member 110 and the first wall 104 are formed by integral injection molding, integral profile extrusion, or the like.

The first direction X may be substantially perpendicular to the arrangement direction Z of the battery cells 210 on the first wall 104. Exemplarily, the battery cells 210 are arranged in a plurality of rows, and the first direction X may be the arrangement direction Z between rows of the battery cells 210.

Optionally, the battery cell 210 can be a square battery, the height direction of the battery cell 210 is parallel to the arrangement direction Z of the battery cell 210 and the first wall 104, a fixing member 110 is provided on one or both sides of the battery cell 210 along the length direction, and the position-limiting member 120 is pressed against an end portion of the battery cell 210 along the height direction. The size of the battery cell 210 in the length direction is greater than that in the width direction, and the size of the battery cell 210 in the length direction may also be greater than that in the height direction.

The connection between the position-limiting member 120 and the fixing member 110 keeps the position-limiting member 120 and the fixing member 110 relatively fixed. Since the fixing member 110 and the first wall 104 are integrated, the position-limiting member 120 and the first wall 104 can be kept relatively fixed, so that the position-limiting member 120 can be pressed against the battery cell 210 to fix the battery cell 210 to the first wall 104. The position-limiting member 120 and the fixing member 110 may be provided as an integral structure, or may be provided to be detachably connected.

The battery apparatus 10 of this embodiment can significantly improve the reliability and stability of the battery apparatus 10. The fixing member 110 and the bottom wall of the box body 100 are integrated, providing a high-strength connection. The fixing member 110 can provide a limiting effect for the battery cell 210, thereby improving the convenience of grouping the battery cells 210. The position-limiting member 120 is connected to the fixing member 110, and the position-limiting member 120 is pressed against the top end of the battery cell 210. The position-limiting member 120 connected to the fixing member 110 has a pressing and limiting effect on the battery cell 210, so that the battery cell 210 can be fixed, and during the grouping and assembly process of the battery cell 210, the battery cell 210 and the first wall 104 are kept relatively fixed, so that the battery cell 210 can be smoothly grouped, and the use of structural adhesive can be reduced or eliminated, thereby reducing the extra weight added by the structural adhesive, improving the energy density of the battery apparatus 10, and at the same time, reducing the dependence on high-precision adhesive coating devices and complex process flow, thereby reducing the manufacturing cost. Also, the battery cell 210 is fixed by the combination of the fixing member 110 and the position-limiting member 120. This fixing method is not easily affected by the temperature and humidity in the process and the external load during the operation of the electrical device, thereby reducing the possibility of connection failure of the battery cell 210 due to debonding, reducing the shaking of the battery cell 210 in the box body 100, and reducing the risk of wear and damage between the battery cells 210 and between the battery cell 210 and the box body 100 due to collision.

According to some embodiments of the present application, optionally, the fixing member 110 and the first wall 104 are of an integrally formed structure.

An integrally formed structure refers to two structures or components being formed into a whole at one time during the manufacturing process. Exemplarily, the fixing member 110 and the first wall 104 can be processed and formed by integral injection molding (or casting), integral profile extrusion, or the like.

It should be noted that the fixing member 110 and the first wall 104 are of an integrally formed structure, which can be understood that the fixing member 110 and the corresponding area of the first wall 104 are of an integrally formed structure. For example, in some embodiments, the first wall 104 itself is formed by splicing multiple plates, and the fixing member 110 and the first wall 104 are of an integrally formed structure. It can be understood that each plate constituting the first wall 104 and the fixing member 110 connected to it are of an integrally formed structure.

The fixing member 110 and the first wall 104 are of an integrally formed structure, and the connection strength between the fixing member 110 and the first wall 104 is relatively high, which can effectively reduce the problem of fixing failure caused by loosening or damage of the connecting portion 1201. At the same time, the integrally formed structure can also improve production efficiency, reduce the number of parts and components, and reduce production costs.

According to some embodiments of the present application, optionally, the first wall 104 and the fixing member 110 are of a structure formed by integral profile extrusion.

That is to say, the first wall 104 and the fixing member 110 are integrally formed from the same raw material (profile) through an extrusion process, and the two form a whole.

The profile forming the first wall 104 and the fixing member 110 has good plasticity, and may specifically be a metal profile or an alloy profile, for example, an aluminum alloy profile, an aluminum profile or a steel profile.

The first wall 104 and the fixing member 110 are formed by integral profile extrusion. This design features easy processing and can achieve close connection and seamless combination of the two, which provides good integrity and connection strength, and can reduce the risk of failure caused by improper connection. At the same time, the fixing member 110 and the first wall 104 themselves and the connection position between the two have good flatness, which is conducive to improving the assembly stability of the battery cell 210.

According to some embodiments of the present application, optionally, the fixing member 110 and the position-limiting member 120 are of an integral structure.

Exemplarily, the fixing member 110 and the position-limiting member 120 may be of an integrally formed structure. For example, the fixing member 110 and the position-limiting member 120 are integrally formed by integral injection molding (or casting), integral profile extrusion, or the like.

Exemplarily, the fixing member 110 and the position-limiting member 120 may be processed separately and then assembled into an integral structure. For example, the fixing member 110 and the position-limiting member 120 may be welded to form an integral structure.

The fixing member 110 and the position-limiting member 120 are of an integral structure, which can improve the connection strength between the fixing member 110 and the position-limiting member 120, can effectively reduce the problem of fixing failure caused by loosening or damage at the connection point, and improve the reliability of the battery apparatus 10.

According to some embodiments of the present application, optionally, the fixing member 110 and the position-limiting member 120 are assembled and connected as separate components.

That is to say, the fixing member 110 and the position-limiting member 120 can be processed separately first, and then assembled and fixed together by corresponding connection methods. For example, the fixing member 110 and the position-limiting member 120 can be processed separately and then connected by welding or riveting.

By assembling and connecting the fixing member 110 and the position-limiting member 120 as separate components, during the assembly of the battery apparatus 10, the battery cell 210 can be first lowered from an end (upper end) of the fixing member 110 away from the first wall 104 onto the first wall 104, and then the position-limiting member 120 can be assembled on the fixing member 110 to make the position-limiting member 120 to press against the battery cell 210. The method of assembling the position-limiting member 120 later can facilitate the lowering of the battery cells 210 into the box body, reduce the interference of the components to the battery cell 210, and improve the assembly efficiency of the battery cell 210.

According to some embodiments of the present application, optionally, the fixing member 110 and the position-limiting member 120 are welded.

The fixing member 110 and the position-limiting member 120 can be welded by laser welding.

The welding process of the fixing member 110 and the position-limiting member 120 can be performed after the battery cell 210 is assembled to the box body 100. The welding process of the electrode terminal 216 of the battery cell 210 and the busbar component can be completed in the same process as the welding process of the fixing member 110 and the position-limiting member 120, which can reduce the production process and improve the production efficiency.

The fixing member 110 is welded to the position-limiting member 120, which can provide higher strength, reduce the number of connecting members, and reduce the possibility of mutual interference between the members.

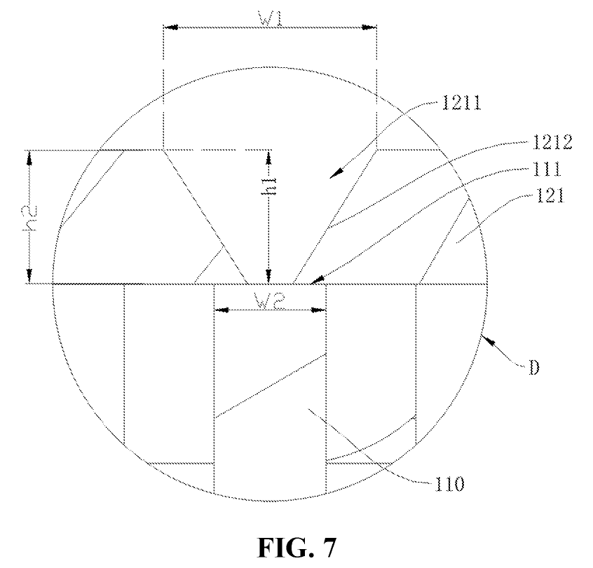

According to some embodiments of the present application, optionally, with reference to FIGS. 4-6, and in combination with FIG. 7, FIG. 7 is an enlarged view of portion D in FIG. 6, the battery cell 210 comprises a case 213, an end of the case 213 away from the first wall is a first end portion 217, the position-limiting member 120 is pressed against the end face of the first end portion 217, an end of the fixing member 110 away from the first wall 104 is a second end portion 111, the position-limiting member 120 is connected to the end face of the second end portion 111, along the arrangement direction Z of the battery cell 210 and the first wall 104, the end face of the first end portion 217 is flush with the end face of the second end portion 111 or the end face of the first end portion 217 is closer to the first wall 104 than the end face of the second end portion 111.

Exemplarily, the arrangement direction Z of the battery cells 210 and the first wall 104 is roughly the height direction (i.e., the vertical direction) of the battery apparatus 10. Along the height direction of the battery apparatus 10, the end face of the second end portion 111 of the fixing member 110 is flush with the end face of the first end portion 217, or the end face of the second end portion 111 is located above the end face of the first end portion 217.

The end face of the second end portion 111 is farther away from the first wall 104 than the end face of the first end portion 217, so that the fixing member 110 can be higher than or flush with the case 213 of the battery cell 210. When the position-limiting member 120 and the fixing member 110 are assembled and connected, they are not easily interfered by the battery cell 210, which improves the assembly convenience between the position-limiting member 120 and the fixing member 110.

According to some embodiments of the present application, optionally, as shown in FIGS. 4-7, the position-limiting member 120 has a connecting portion 1201, the connecting portion 1201 is arranged corresponding to the end face of the second end portion 111, and the position-limiting member 120 is connected to the end face of the second end portion 111 through the connecting portion 1201.

The connecting portion 1201 is arranged corresponding to the end face of the second end portion 111. It can be understood that the connecting portion 1201 is located on the end face of the second end portion 111. In other words, the positive projection of the connecting portion 1201 along the arrangement direction Z of the battery cell 210 and the first wall 104 is located on the second end portion 111.

The connecting portion 1201 may be an assembly hole of the fixing member 110, or a protrusion that is partially protruded relative to the fixing member 110. The assembly hole can be fitted with a fastener to connect the fixing member 110 with the position-limiting member 120, and the assembly hole can also be used as a welding hole 1211 for welding. The welding hole 1211 is processed by laser welding or other methods to weld the fixing member 110 with the position-limiting member 120; the protrusion can make the fixing member 110 connected with the position-limiting member 120 in conjunction with welding, snap fit or other methods.

By providing a connecting portion 1201 corresponding to the end face of the second end portion 111, the connecting portion 1201 is located on the end face of the second end portion 111, which facilitates the connection between the fixing member 110 and the position-limiting member 120 and reduces the possibility of interference between the connection position of the fixing member 110 and the position-limiting member 120 and the battery cell 210.

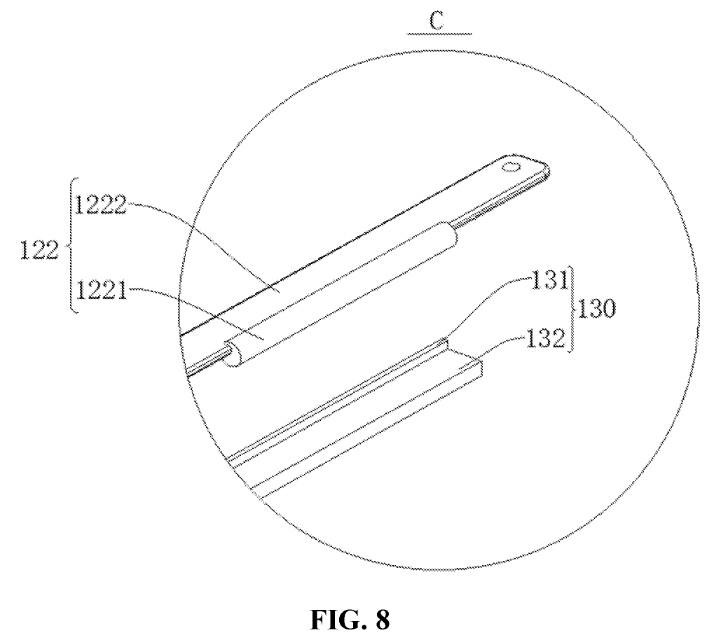

According to some embodiments of the present application, optionally, as shown in FIGS. 4-7, and in combination with FIG. 8, FIG. 8 is an enlarged view of portion C in FIG. 1, the position-limiting member 120 and the fixing member 110 extend along the second direction Y, and the position-limiting member 120 is provided with a plurality of connecting portions 1201 at intervals along the second direction Y, and the first direction X, the second direction Y, and the arrangement direction Z of the battery cells 210 and the first wall 104 intersect with each other.

The arrangement direction Z of the battery cell 210 and the first wall 104, the second direction Y and the first direction X may be approximately perpendicular to each other.

Exemplarily, the first direction X may be the width direction of the battery apparatus 10, the second direction Y may be the length direction of the battery apparatus 10, and the arrangement direction Z of the battery cell 210 and the first wall 104 may be the height direction of the battery apparatus 10.

Exemplarily, along the second direction Y, a plurality of connecting portions 1201 may be arranged on the position-limiting member 120 at equal intervals.

Along the second direction Y, the sum of the sizes of the plurality of connecting portions 1201 may be greater than or equal to half the length of the fixing member 110.

The position-limiting member 120 is provided with a plurality of connecting portions 1201 spaced apart, which can improve the connection stability between the fixing member 110 and the position-limiting member 120; when the connecting portions 1201 are provided for welding, the connecting portions 1201 are provided in a dispersed manner, and the welding convenience and welding reliability are better.

According to some embodiments of the present application, optionally, as shown in FIGS. 4-7, at least one position-limiting member 120 is a first position-limiting member 121, the connecting portion 1201 is a welding hole 1211, the first position-limiting member 121 is welded to the corresponding fixing member 110 through the welding hole 1211, and the two hole walls of the welding hole 1211 opposite to each other in the first direction X are first hole walls 1212, and the two first hole walls 1212 are inclined away from each other from an end facing the fixing member 110 to an end away from the fixing member 110.

The welding hole 1211 may correspond to the end face of the second end portion 111, and the position-limiting member 120 may be connected to the second end portion 111 of the fixing member 110 through the welding hole 1211 by laser welding or other methods.

Exemplarily, the welding hole 1211 may be arranged in the middle of the first position-limiting member 121 along the first direction X, and along the arrangement direction Z of the battery cell 210 and the first wall 104, the welding hole 1211 passes through the opposite sides of the first position-limiting member 121.

The two first hole walls 1212 are inclined away from each other from an end facing the fixing member 110 to an end away from the fixing member 110. That is, the connecting hole is expanded from an end facing the fixing member 110 to an end away from the fixing member 110.

One end or both ends of the first position-limiting member 121 provided with the welding hole 1211 along the first direction X may protrude relative to the position-limiting member 120 to form a pressing portion, and the pressing portion is used to press the end portion of the battery cell 210.

The connecting portion 1201 is arranged as a welding hole 1211, which facilitates welding of the first position-limiting member 121 to the corresponding fixing member 110. The welding hole 1211 is arranged in a form in which the first hole wall 1212 is inclined, and an end of the welding hole 1211 close to the fixing member 110 is narrower, while an end away from the fixing member 110 is wider, so that during the welding process, the interference and shielding of the first hole wall 1212 to the welding position is reduced, the convenience of the welding operation is improved, which is conducive to improving the welding quality and reducing the possibility of false welding.

According to some embodiments of the present application, optionally, the angle between the two first hole walls 1212 is 20° to 80°; and/or, along the arrangement direction Z of the battery cell 210 and the first wall 104, the depth of the welding hole 1211 is greater than or equal to the thickness of the first position-limiting member 121; and/or, the maximum width of the welding hole 1211 along the first direction X is less than or equal to the thickness of the first position-limiting member 121 along the arrangement direction Z of the battery cell 210 and the first wall 104.

Optionally, the angle α between the two first hole walls 1212 is 20° to 80°, and specifically may be 20°, 30°, 40°, 50°, 60°, 65°, 70°, 75°, 80°.

The inclinations of the two first hole walls 1212 may be the same. For example, the two first hole walls 1212 may be arranged in mirror symmetry.

By setting the angle α between the two first hole walls 1212 to 20° to 80°, the interference and shielding of the first hole walls 1212 to the welding position is reduced during the welding process, which improves the convenience of welding operation, helps to improve welding quality, and reduces the possibility of false welding.

Optionally, along the arrangement direction Z of the battery cell 210 and the first wall 104, the depth h1 of the welding hole 1211 is greater than or equal to the thickness h2 of the first position-limiting member 121.

The depth h1 of the welding hole 1211 refers to the extension length of the welding hole 1211 along its own axial direction (its axial direction is consistent with the arrangement direction Z of the battery cell 210 and the first wall 104). The thickness h2 of the first position-limiting member 121 refers to the maximum thickness of the main body part of the first position-limiting member 121 along the arrangement direction Z of the battery cell 210 and the first wall 104.

Exemplarily, the first position-limiting member 121 is roughly a flat plate, and the position of the welding hole 1211 enclosed by the first position-limiting member 121 is the same as the thickness of its main body part. Along the arrangement direction Z of the battery cell 210 and the first wall 104, the two ends of the hole wall of the welding hole 1211 are respectively flush with the two ends of the first position-limiting member 121, and the depth h1 of the welding hole 1211 is equal to the thickness h2 of the first position-limiting member 121.

Exemplarily, the first position-limiting member 121 is roughly a flat plate, and the first position-limiting member 121 is provided with a reinforcing protrusion, which encloses the welding hole 1211 and is located on a side of the first position-limiting member 121 away from the fixing member 110. That is to say, the first position-limiting member 121 is provided with a protruding reinforcing protrusion at the position of the welding hole 1211, and a through welding hole 1211 is provided between the reinforcing protrusion and the first position-limiting member 121. In this way, along the arrangement direction Z of the battery cell 210 and the first wall 104, an end of the hole wall of the welding hole 1211 away from the fixing member 110 protrudes relative to the first position-limiting member 121, and the depth h1 of the welding hole 1211 is greater than the thickness h2 of the first position-limiting member 121.

It should be noted that the maximum upper limit of the depth h1 of the welding hole 1211 is not too large, and generally does not exceed twice the thickness h2 of the first position-limiting member 121.

By making the depth of the welding hole 1211 greater than or equal to the thickness of the first position-limiting member 121, the connection strength between the first position-limiting member 121 and the fixing member 110 welded through the welding hole 1211 can be improved.

Optionally, the maximum width W1 of the welding hole 1211 along the first direction X is less than or equal to the thickness h1 of the first position-limiting member 121 along the arrangement direction Z of the battery cell 210 and the first wall 104.

The maximum width W1 of the welding hole 1211 along the first direction X refers to the size of an end of the welding hole 1211 away from the fixing member 110 along the first direction X.

The maximum width W1 of the welding hole 1211 along the first direction X may be set to be greater than 1/3 of the thickness h1 of the first position-limiting member 121 and less than or equal to the thickness h1 of the first position-limiting member 121. Exemplarily, the maximum width W1 of the welding hole 1211 may be set to be 1/2 or 2/3 of the thickness h1 of the first position-limiting member 121, or the maximum width W1 of the welding hole 1211 may be set to be the thickness h1 of the first position-limiting member 121.

Optionally, the maximum width W1 of the welding hole 1211 along the first direction X is less than or equal to 1/2 of the width of the first position-limiting member 121 itself, the maximum width W1 of the welding hole 1211 along the first direction X can be greater than the width W2 of the second end portion 111 of the fixing member 110, and the minimum width of the welding hole 1211 along the first direction X can be greater than the width W2 of the second end portion 111 of the fixing member 110.

By designing the welding hole 1211 to have a maximum width W1 along the first direction X that is less than or equal to the thickness h1 of the first position-limiting member 121, the connection strength between the first position-limiting member 121 and the fixing member 110 through the welding hole 1211 can be improved, and the influence of the welding hole 1211 on the strength of the fixing member 110 can be reduced.

According to some embodiments of the present application, optionally, along the first direction X, the first position-limiting member 121 is arranged between two adjacent battery cells 210, and both sides of the first position-limiting member 121 protrude relative to the fixing member 110 to form first pressing portions 1213, and the first pressing portions 1213 on both sides of the first position-limiting member 121 are respectively pressed against the two adjacent battery cells 210.

The first position-limiting member 121 can be arranged between two rows of battery cells 210. By arranging a fixing member 110 and a first position-limiting member 121 connected thereto, the battery cells 210 on both sides can be pressed and fixed. The structure is simple, the space occupied by the fixing member 110 and the manufacturing cost can be reduced, and the energy density of the battery apparatus 10 can be improved.

According to some embodiments of the present application, optionally, as shown in FIGS. 4, 5 and 8, at least one said position-limiting member 120 is a second position-limiting member 122, and along the first direction X, one side of the second position-limiting member 122 protrudes relative to the fixing member 110 to form a second pressing portion 1222, the second pressing portion 1222 of the second position-limiting member 122 is pressed and matched with the battery cell 210, a welding protrusion 1221 is provided on the other side of the second position-limiting member 122 opposite to the second pressing portion 1222, the welding protrusion 1221 is the connecting portion 1201, and the second position-limiting member 122 is welded to the fixing member 110 through the welding protrusion 1221.

The welding protrusion 1221 may be a solid bump structure, and the welding protrusion 1221 and the second position-limiting member 122 may be of an integrally formed structure. The welding protrusion 1221 may be located on an end face of the second end portion 111 of the corresponding fixing member 110.

The second position-limiting members 122 may be located at both ends of all the battery cells 210 along the first direction X, and are used to press the battery cells 210 located at both sides of the edge along the first direction X.

Along the first direction X, the second position-limiting member 122 is provided with a second pressing portion 1222 on the side facing the battery cell 210, and the side opposite to the battery cell 210 is welded to the fixing member 110 through the welding protrusion 1221. The structure is simple and the welding operation is convenient. Moreover, the connecting portion 1201 is set as a welding protrusion 1221, which is not easy to affect the strength of the second position-limiting member 122.

According to some embodiments of the present application, optionally, as shown in FIGS. 4-6, an electrode terminal 216 is provided on a side of the battery cell 210 away from the first wall 104, and along the first direction X, the position-limiting member 120 is located on one side of the electrode terminal 216 and is spaced apart from the electrode terminal 216.

Optionally, each battery cell 210 may be provided with a position-limiting member 120 on both sides in the first direction X, the position-limiting members 120 on both sides are respectively connected to the fixing members 110 and can be connected to the first wall 104 through the fixing members 110, and the position-limiting members 120 on both sides may be arranged on both sides of the electrode terminal 216.

The position-limiting member 120 is located on one side of the electrode terminal 216 and is spaced apart from the electrode terminal 216, which can reduce the interference of the position-limiting member 120 to the electrode terminal 216, reduce the possibility of short circuit of the battery cell 210, and improve the reliability of the battery apparatus 10.

According to some embodiments of the present application, optionally, as shown in FIGS. 4-6, a first buffer member 130 is arranged between the position-limiting member 120 and the battery cell 210.

The first buffer member 130 may be a rubber or soft plastic pad, etc. The first buffer member 130 may also be a glue layer formed after glue is dried. The first buffer member 130 has a certain buffering performance.

The first buffer member 130 can play a buffering and protective role, reduce the possibility of the battery cell 210 being damaged by the position-limiting member 120, and improve the reliability of the battery apparatus 10.

According to some embodiments of the present application, optionally, according to some embodiments of the present application, optionally, the first buffer member 130 is configured as an insulating structure.

Exemplarily, the first buffer member 130 may be provided with an insulating structure, where the insulating structure refers to a device having an electrical isolation function. The first buffer member 130 is configured as an insulating structure, which can reduce the possibility of short circuit caused by electrical connection between the battery cell 210 and the position-limiting member 120, thereby improving the reliability of the battery apparatus 10.

Exemplarily, the first buffer member 130 may be configured as a thermally conductive structure 170, where the thermally conductive structure 170 refers to a device with good thermal conductivity. The first buffer member 130 is configured as a thermally conductive structure 170, which can improve the heat dissipation performance of the battery cell 210.

According to some embodiments of the present application, optionally, as shown in FIGS. 4-7, the battery cell 210 includes a case 213 and an electrode terminal 216, an end of the case 213 away from the first wall is a first end portion 217, the electrode terminal 216 is located at the first end portion 217, the position-limiting member 120 is pressed against the first end portion 217, the first buffer member 130 comprises a first part 131 and a second part 132, the first part 131 is arranged between the position-limiting member 120 and the electrode terminal 216, and the second part 132 is arranged between the position-limiting member 120 and the first end portion 217.

The first end portion 217 may be understood with reference to the end cover 214.

The first part 131 and the second part 132 can be provided separately or as an integral structure. Exemplarily, the first part 131 and the second part 132 are of an integrally formed structure.

Exemplarily, the first part 131 may be attached to the position-limiting member 120, and the first part 131 and the position-limiting member 120 may be spaced apart.

Exemplarily, the second part 132 may be pressed between the position-limiting member 120 and the first end portion 217.

The first part 131 can reduce the possibility of the position-limiting member 120 damaging the electrode terminal 216, and the second part 132 can reduce the possibility of the position-limiting member 120 damaging the case 213, thereby improving the reliability of the battery apparatus 10.

According to some embodiments of the present application, optionally, a second buffer member 140 is arranged between the fixing member 110 and the battery cell 210.

The second buffer member 140 may be a rubber or soft plastic pad, etc. The second buffer member 140 may also be a glue layer formed after glue is dried. The second buffer member 140 has a certain buffering performance.

The second buffer member 140 may cover the entire area between the fixing member 110 and the battery cell 210, or the second buffer member 140 may be provided only in a partial area between the fixing member 110 and the battery cell 210.

The second buffer member 140 can play a buffering and protective role, reduce the possibility of the battery cell 210 being damaged by the fixing member 110, and improve the reliability of the battery apparatus 10.

According to some embodiments of the present application, optionally, as shown in FIGS. 4-6, the second buffer member 140 comprises a first sub-buffer member 141, the first sub-buffer member 141 is arranged between an end of the fixing member 110 facing the position-limiting member 120 and the battery cell 210, the first buffer member 130 is arranged between the position-limiting member 120 and the battery cell 210, and the first buffer member 130 and the first sub-buffer member 141 are of an integral structure.

The first buffer member 130 and the first sub-buffer member 141 are connected into a whole, and the two can be placed on the shoulder of the battery cell 210 simultaneously to protect the shoulder of the battery cell 210, thereby improving the convenience of operation and the protection performance.

According to some embodiments of the present application, optionally, as shown in FIGS. 4-6, a third buffer member 150 is arranged between the first wall 104 and the battery cell 210.

The third buffer member 150 may be a rubber or soft plastic pad, etc. The third buffer member 150 may also be a glue layer formed after glue is dried. The third buffer member 150 has a certain buffering performance.

The third buffer member 150 may cover the entire area between the first wall 104 and the battery cell 210, or the third buffer member 150 may be provided only in a partial area between the first wall 104 and the battery cell 210.

The third buffer member 150 can play a buffering and protective role, reduce the possibility of the battery cell 210 being damaged by the first wall 104, and improve the reliability of the battery apparatus 10.

According to some embodiments of the present application, optionally, as shown in FIGS. 4-6, a second buffer member 140 is arranged between the fixing member 110 and the battery cell 210, the second buffer member 140 includes a second sub-buffer member 142. The second sub-buffer member 142 is provided between an end of the fixing member 110 away from the position-limiting member 120 and the battery cell 210. The second sub-buffer member 142 and the third buffer member 150 are of an integral structure.

The second sub-buffer member 142 may be a portion of the second buffer member 140.

The third buffer member 150 may be arranged only between an end portion of the battery cell 210 in the first direction X and the first wall 104.

The second sub-buffer member 142 and the third buffer member 150 are of an integral structure, and the two can be placed on the bottom shoulder of the battery cell 210 simultaneously to protect the shoulder of the battery cell 210, thereby improving the convenience of operation and the protection performance.

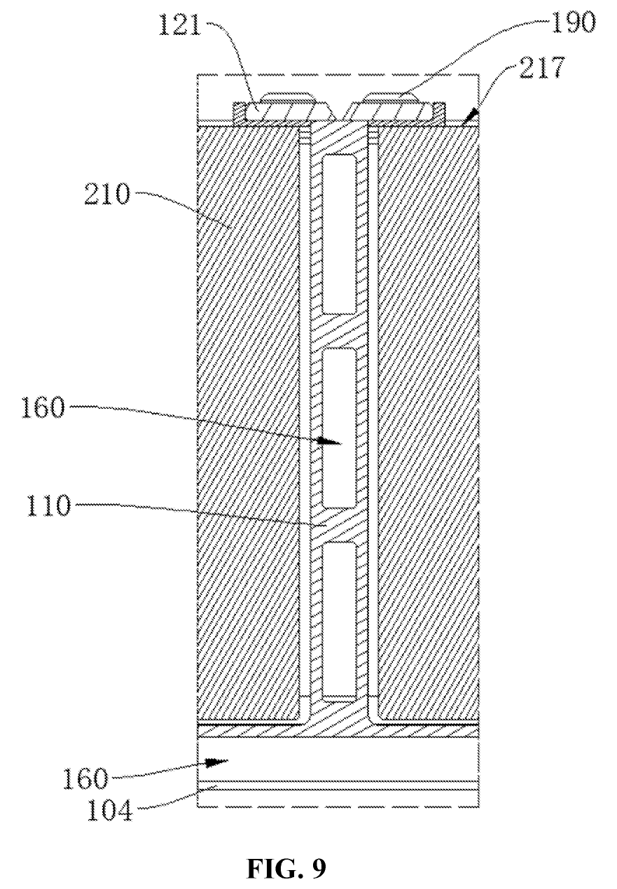

According to some embodiments of the present application, optionally, as shown in FIGS. 4-6, and in combination with FIG. 9, FIG. 9 is a schematic partial section view of a battery apparatus according to some embodiments of the present application, a flow channel 160 for a heat exchange medium to flow is provided in the first wall 104; and/or a flow channel 160 for a heat exchange medium to flow is provided in the fixing member 110; and/or a flow channel 160 for a heat exchange medium to flow is provided in the position-limiting member 120.

The heat exchange medium can be a liquid, such as an aqueous solution with antifreeze, etc.; the heat exchange medium can also be a refrigerant, etc.

Exemplarily, a flow channel 160 for a heat exchange medium to flow is provided in the first wall 104, and the first wall 104 may be a liquid cooling plate.

Exemplarily, a flow channel 160 for a heat exchange medium to flow is provided in the fixing member 110.

Exemplarily, a flow channel 160 for a heat exchange medium to flow is provided in the position-limiting member 120.

The flow channel 160 in the first wall 104 and the flow channel 160 in the fixing member 110 can be communicated, or the heat exchange medium can flow through each of them independently; the flow channel 160 of the fixing member 110 and the flow channel 160 of the position-limiting member 120 can be communicated, or the heat exchange medium can flow through each of them independently.

By arranging flow channels 160 in the first wall 104, the fixing member 110 and/or the position-limiting member 120, the heat exchange medium flowing through the flow channels 160 can exchange heat with the battery cells 210, thereby adjusting the temperature of the battery cells 210, realizing a thermal pipeline for the battery apparatus 10, and improving the reliability of the battery apparatus 10.

According to some embodiments of the present application, optionally, a thermally conductive structure 170 is arranged between the first wall 104 and the battery cell 210; and/or, a thermally conductive structure 170 is arranged between the fixing member 110 and the battery cell 210; and/or, a thermally conductive structure 170 is arranged between the position-limiting member 120 and the battery cell 210.

The thermally conductive structure 170 may be a thermally conductive pad or thermally conductive glue, etc., wherein the thermally conductive pad may be fixed by means of adhesion. The thermally conductive structure 170 and the buffer member at the corresponding position may be of an integral structure, that is, the buffer member may be provided as the thermally conductive structure 170, and the thermally conductive structure 170 may also have buffering performance.

By providing a thermally conductive structure 170, the thermal conduction efficiency of the battery cell 210 can be improved, the temperature regulation capability of the battery cell 210 can be improved, and the reliability of the battery apparatus 10 can be improved.

According to some embodiments of the present application, optionally, along the second direction Y, the box body 100 has a second wall 105 and a third wall 106 opposite to each other, the second wall 105 and the third wall 106 are respectively connected to the first wall 104, and both enclose the accommodating cavity 103, along the second direction Y, the two ends of the position-limiting member 120 are respectively connected to the second wall 105 and the third wall 106, and/or, the two ends of the fixing member 110 are respectively connected to the second wall 105 and the third wall 106, and the first direction X, the second direction Y and the arrangement direction Z of the battery cell 210 and the first wall 104 intersect with each other.

Optionally, along the second direction Y, the two ends of the position-limiting member 120 are connected to the second wall 105 and the third wall 106 respectively. Specifically, the two ends of the position-limiting member 120 are respectively connected to the second wall 105 and the third wall 106 by welding, riveting, bolting, etc.

Exemplarily, as shown in FIGS. 4-9, the two ends of the position-limiting member 120 along the second direction Y are riveted by rivet nuts 190.

Optionally, along the second direction Y, the two ends of the fixing member 110 are connected to the second wall 105 and the third wall 106 respectively. Specifically, the two ends of the fixing member 110 are respectively connected to the second wall 105 and the third wall 106 by welding, riveting, bolting, etc.

Exemplarily, the second wall 105 and the third wall 106 are provided with plugging holes, both ends of the fixing member 110 are inserted into the plugging holes, and the plugging portion thereof is welded to the second wall 105 or the third wall 106.

The second wall 105 and the third wall 106 may be part of a frame of the box body 100. The second wall 105 may be an expansion beam arranged inside the box body 100, or a side beam of the box body 100; the third wall 106 may be an expansion beam arranged inside the box body 100, or a side beam of the box body 100.

The position-limiting member 120 and/or the fixing member 110 are connected to the second wall 105 and the third wall 106 of the box body 100, which can improve the overall rigidity of the box body 100, improve the fixing effect on the battery cell 210, and increase the resistance of the box body 100 to expansion force.

According to some embodiments of the present application, optionally, as shown in FIGS. 4-9, a plurality of battery cells 210 are provided, and the plurality of battery cells 210 are provided in at least one row, each row includes a plurality of battery cells 210 arranged along the second direction Y, the position-limiting member 120 and the fixing member 110 extend along the second direction Y, the position-limiting member 120 is pressed against a plurality of battery cells 210 in the same row adjacent thereto, and the first direction X, the second direction Y and the arrangement direction Z of the battery cell 210 and the first wall 104 intersect with each other.

Exemplarily, the battery cells 210 may be square batteries, and the large surfaces of two adjacent battery cells 210 in the same row are arranged to face each other.

The second direction Y is the arrangement direction Z of the plurality of battery cells 210 in the same row, and the first direction X is the arrangement direction Z between the rows. The plurality of battery cells 210 in the same row may be considered as a battery cell assembly 200, that is, a battery module.

Exemplarily, the position-limiting member 120 may be pressed against all the battery cells 210 in the same row adjacent thereto.

The position-limiting member 120 extends along the arrangement direction Z of the battery cells 210 in the same row and can be pressed against a plurality of battery cells 210 at the same time. It has a simple structure and is convenient to arrange, which is conducive to improving assembly efficiency.

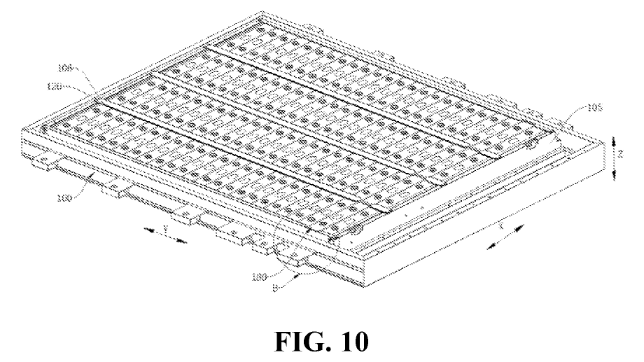

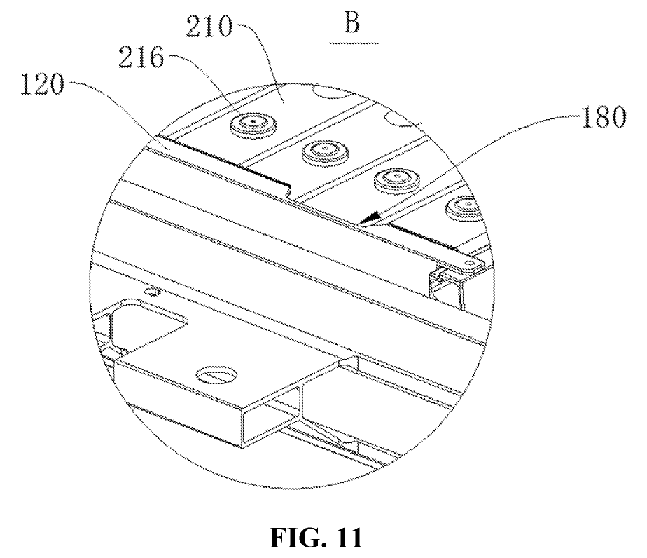

Referring to FIGS. 10 and 11, FIG. 10 is a partial structural diagram of a battery apparatus according to in some embodiments of the present application, and FIG. 11 is an enlarged view of portion B in FIG. 10. According to some embodiments of the present application, optionally, along the second direction Y, the position-limiting member 120 is provided with an avoidance slot 180, the avoidance slot 180 is configured to allow at least one battery cell 210 to pass through, and the battery cell 210 is configured to be able to slide relative to the position-limiting member 120 and the fixing member 110 along the second direction Y.

The position-limiting member 120 may be provided with an avoidance notch 180 in a local area along the second direction Y. The battery cell 210 may be lowered from the avoidance notch 180 onto the first wall 104 and then slide into place along the extension direction (second direction Y) of the position-limiting member 120 and the fixing member 110. In this way, when assembling the battery apparatus 10, the battery cells 210 can be assembled in the box body 100 after the position-limiting member 120 and the fixing member 110 are assembled. The assembly time and assembly method of the position-limiting member 120 and the fixing member 110 are more flexible.

According to some embodiments of the present application, optionally, a heating member (not shown) is provided on the fixing member 110 and/or the position-limiting member 120.

The heating member may be a heating film, and in particular may be an electric heating film.

A heating member may be provided on a side of the fixing member 110 facing the battery cell 210, and a heating member may be provided on a side of the position-limiting member 120 facing the battery cell 210.

Exemplarily, the heating member may be fixed to the position-limiting member 120 or the fixing member 110 by means of adhesion.

By providing a heating member, the battery cell 210 can be heated to improve the thermal management performance of the battery apparatus 10.

According to some embodiments of the present application, optionally, as shown in FIGS. 4-11, the first wall 104 is the bottom wall of the box body 100.

The bottom wall refers to the wall of the box body 100 located below the battery cells 210 when the battery apparatus 10 is in a normal use state.

According to some embodiments of the present application, optionally, along the second direction Y, the box body 100 has a second wall 105 and a third wall 106 opposite to each other, the second wall 105 and the third wall 106 are respectively connected to the first wall 104, and both enclose the accommodating cavity 103, and the second wall 105, the third wall 106 and the first wall 104 are of an integrally formed structure.

The second wall 105 and the third wall 106 are part of the frame of the box body 100, and the second wall 105, the third wall 106 and the first wall 104 may be of a structure formed by integral profile extrusion. The fixing member 110, the second wall 105, the third wall 106 and the first wall 104 may all be of a structure formed by integral profile extrusion.

The second wall 105, the third wall 106 and the first wall 104 are configured as an integrally formed structure, which is convenient to process and also enhances the strength of the box body 100.

As shown in FIGS. 2-9, an embodiment of the present application provides a battery apparatus 10 comprising a box body 100, a plurality of battery cells 210 and a position-limiting member 120, the box body 100 has an accommodating cavity, a first wall 104, a second wall 105 and a third wall 106, the first wall 104 is the bottom wall of the box body 100, and the second wall 105 and the third wall 106 are two side walls of the box body 100 opposite to each other along the second direction Y, wherein the first wall 104, the second wall 105 and the third wall 106 all enclose the accommodating cavity, a plurality of battery cells 210 are arranged in the accommodating cavity 103 and are all supported on the first wall 104, the plurality of battery cells 210 are arranged in a plurality of rows along the first direction X, and each row of battery cells 210 have a plurality of battery cells 210 sequentially arranged along the second direction Y. The first wall 104, the second wall 105 and the third wall 106 are formed by integral profile extrusion, and a plurality of fixing members 110 are integrally extruded on a side of the first wall 104 facing the accommodating cavity 103. Along the first direction X, fixing members 110 are arranged between adjacent rows of battery cells 210 and at both ends of all battery cells 210. The position-limiting member 120 is arranged in the accommodating cavity 103, and comprises a first position-limiting member 121 and a second position-limiting member 122, wherein the fixing members 110 located at both ends of all battery cells 210 along the first direction X are connected to the second position-limiting member 122, and the fixing members 110 located between adjacent rows of battery cells 210 are connected to the first position-limiting member 121. Along the first direction X, one side of the second position-limiting member 122 facing the battery cell 210 protrudes relative to the fixing member 110 to form a second pressing portion 1222, and a welding protrusion 1221 is provided on the other side of the second position-limiting member 122 opposite to the second pressing portion 1222. The second pressing portion 1222 of the second position-limiting member 122 is pressed against and matched with an end of the battery cell 210 away from the first wall 104, and the welding protrusion 1221 is a connecting portion 1201. The welding protrusion 1221 corresponds to the end face (the end face of the second end portion 111) of its corresponding fixing member 110, and the second position-limiting member 122 is welded to the corresponding fixing member 110 through the welding protrusion 1221; wherein, the second position-limiting member 122 and its corresponding fixing member 110 are respectively connected to the second wall 105 and the third wall 106, and along the second direction Y, the second pressing portion 1222 is pressed against all the battery cells 210 in a row adjacent thereto. Along the first direction X, the first position-limiting member 121 is arranged between two adjacent battery cells 210, and both sides of the first position-limiting member 121 protrude relative to the fixing member 110 to form first pressing portions 1213, and the first pressing portions 1213 on both sides of the first position-limiting member 121 are pressed against two adjacent battery cells 210 respectively, wherein the first position-limiting member 121 and its corresponding fixing member 110 are respectively connected to the second wall 105 and the third wall 106, and along the second direction Y, the two first pressing portions 1213 are pressed against all battery cells 210 in two adjacent rows respectively; a welding hole 1211 is arranged in the middle of the first position-limiting member 121, the welding hole 1211 corresponds to the end face (end face of the second end portion 111) of its corresponding fixing member 110, the first position-limiting member 121 is welded to the corresponding fixing member 110 through the welding hole 1211, the two hole walls opposite to each other in the first direction X of the welding hole 1211 are the first hole walls 1212, the two first hole walls 1212 are inclined away from each other from an end facing the fixing member 110 to an end away from the fixing member 110, and the angle between the two first hole walls 1212 is 20° to 80°; along the arrangement direction Z of the battery cell 210 and the first wall 104, the depth h1 of the welding hole 1211 is greater than or equal to the thickness h2 of the first position-limiting member 121; the maximum width W1 of the welding hole 1211 along the first direction X is less than or equal to the thickness of the first position-limiting member 121 along the arrangement direction Z of the battery cell 210 and the first wall 104. The battery cell 210 comprises a case 213, an end of the case 213 away from the first wall is a first end portion 217, a position-limiting member 120 is pressed against the end face of the first end portion 217, an end of the fixing member 110 away from the first wall 104 is a second end portion 111, the position-limiting member 120 is connected to the end face of the second end portion 111, and along the arrangement direction Z of the battery cell 210 and the first wall 104, the end face of the first end portion 217 is arranged closer to the first wall 104 than the end face of the second end portion 111. An electrode terminal 216 is provided on a side of the battery cell 210 away from the first wall 104, and along the first direction X, the position-limiting member 120 is located on one side of the electrode terminal 216 and is spaced apart from the electrode terminal 216. A first buffer member 130 is arranged between the position-limiting member 120 and the battery cell 210, and the first buffer member 130 is configured as an insulating structure. The first buffer member 130 comprises a first part 131 and a second part 132, the first part 131 is arranged between the position-limiting member 120 and the electrode terminal 216, and the second part 132 is arranged between the position-limiting member 120 and the first end portion 217. A first sub-buffer member 141 is arranged between an end of the fixing member 110 facing the position-limiting member 120 and the battery cell 210, a first buffer member 130 is arranged between the position-limiting member 120 and the battery cell 210, and the first buffer member 130 and the first sub-buffer member 141 are of an integral structure. A second sub-buffer member 142 is arranged between an end of the fixing member 110 away from the position-limiting member 120 and the battery cell 210, and the second sub-buffer member 142 and the third buffer member 150 are of an integral structure. A flow channel 160 for a heat exchange medium to flow is provided in the first wall 104; a flow channel 160 for a heat exchange medium to flow is provided in the fixing member 110. A thermally conductive structure 170 is arranged between the first wall 104 and the battery cell 210. The second wall 105 and the third wall 106 may be configured as expansion beams of the box body 100 to resist the expansion force of the battery cell 210. The first direction X is the width direction of the battery apparatus 10, the second direction Y is the length direction of the battery apparatus 10, and the arrangement direction Z of the battery cell 210 and the first wall 104 is the height direction of the battery apparatus 10. The fixing member 110 and the position-limiting member 120 can both be of a plate-shaped or strip-shaped structure.

When assembling the battery apparatus 10 of this embodiment, the battery cell 210 is assembled into the box body 100 along the height direction of the battery apparatus 10 (the arrangement direction Z of the battery cell 210 and the first wall 104), and after the battery cell 210 is placed in the box body, a buffer member is mounted on the shoulder of the battery cell 210, and then the position-limiting member 120 is pressed against the insulating buffer pad, the position-limiting member 120 is connected and fixed to the fixing member 110 by laser welding, and then the position-limiting member 120 is connected to the second wall 105 and the third wall 106 by using rivets or the like.

Some embodiments of the present application further provide an electrical device, which comprises the battery apparatus 10 proposed in the present application or any embodiment of the present application, and the battery apparatus 10 is used for storing electric energy or providing electric energy.

The electrical device may be any of the aforementioned electrical apparatuses or systems.

The electrical device of this embodiment has the same beneficial effects as the battery apparatus 10 proposed in the present application or any embodiment of the present application.

Unless otherwise specified, all the embodiments and optional embodiments of the present application can be combined with each other form new technical solutions. The above description of the embodiments tends to emphasize the differences between the embodiments, and the same or similar aspects thereof can be referenced to each other. For the sake of simplicity, it will not be repeated here.

Finally, it should be noted that: the above embodiments are merely used to illustrate the technical solutions of the present application, instead of imposing any limitation on the present application. Although the present application has been described in detail with reference to the above embodiments, those with ordinary skills in the art should understand that: the technical solutions disclosed in the above embodiments may still be modified, or a part or all of the technical features thereof may be replaced equivalently. These modifications and replacements are not intended to make the essence of corresponding technical solutions depart from the scope of the technical solutions of the embodiments of the present application, and should be encompassed within the scope of the claims and specification of the present application. In particular, the technical features mentioned in the various embodiments can be combined in any manner as long as there is no structural conflict. The present application is not limited to the particular embodiments disclosed herein, but rather includes all technical solutions falling within the scope of the claims.

What is claimed is:

1. A battery apparatus, comprising:
a battery cell;
a box body, having an accommodating cavity and a first wall, wherein the first wall is arranged at one side of the accommodating cavity, the battery cell is arranged in the accommodating cavity and supported on the first wall, a fixing member is arranged on the first wall, the fixing member and the first wall are of an integral structure, the fixing member is arranged in the accommodating cavity and located at a side of the battery cell along a first direction, and the first direction intersects with an arrangement direction of the battery cell and the first wall; and
a position-limiting member, arranged in the accommodating cavity, wherein along the arrangement direction of the battery cell and the first wall, the position-limiting member is connected to an end of the fixing member away from the first wall and pressed against an end of the battery cell away from the first wall.

2. The battery apparatus according to claim 1, wherein the fixing member and the first wall are of an integrally formed structure.

3. The battery apparatus according to claim 2, wherein the first wall and the fixing member are of a structure formed by integral profile extrusion.

4. The battery apparatus according to claim 1, wherein the fixing member and the position-limiting member are provided as an integral structure.

5. The battery apparatus according to claim 1, wherein the fixing member and the position-limiting member are assembled and connected as separate components.

6. The battery apparatus according to claim 5, wherein the fixing member and the position-limiting member are welded.

7. The battery apparatus according to claim 1, wherein the battery cell comprises a case, an end of the case away from the first wall is a first end portion, the position-limiting member is pressed against the end face of the first end portion, an end of the fixing member away from the first wall is a second end portion, the position-limiting member is connected to the end face of the second end portion, and along the arrangement direction of the battery cell and the first wall, the end face of the first end portion is flush with the end face of the second end portion or the end face of the first end portion is closer to the first wall than the end face of the second end portion.

8. The battery apparatus according to claim 7, wherein the position-limiting member has a connecting portion, the connecting portion is arranged corresponding to the end face of the second end portion, and the fixing member is connected to the end face of the second end portion through the connecting portion.

9. The battery apparatus according to claim 8, wherein the position-limiting member and the fixing member extend along a second direction, the position-limiting member has a plurality of connecting portions spaced apart along the second direction, and the first direction, the second direction, and the arrangement direction of the battery cell and the first wall intersect with each other.

10. The battery apparatus according to claim 8, wherein the position-limiting member is a first position-limiting member, the connecting portion is a welding hole, the first position-limiting member is welded to the corresponding fixing member through the welding hole, the two hole walls of the welding hole opposite to each other in the first direction are first hole walls, and the two first hole walls are inclined away from each other from an end facing the fixing member to an end away from the fixing member.

11. The battery apparatus according to claim 10, wherein:
the angle between the two first hole walls is 20° to 80°; and/or
along the arrangement direction of the battery cell and the first wall, the depth of the welding hole is greater than or equal to the thickness of the first position-limiting member; and/or
the maximum width of the welding hole along the first direction is less than or equal to the thickness of the first position-limiting member along the arrangement direction of the battery cell and the first wall.

12. The battery apparatus according to claim 10, wherein along the first direction, the first position-limiting member is arranged between two adjacent battery cells, and both sides of the first position-limiting member protrude relative to the fixing member to form first pressing portions, and the first pressing portions on both sides of the first position-limiting member are respectively pressed against the two adjacent battery cells.

13. The battery apparatus according to claim 8, wherein the position-limiting member is a second position-limiting member, along the first direction, one side of the second position-limiting member protrudes relative to the fixing member to form a second pressing portion, a welding protrusion is provided on the other side of the second position-limiting member opposite to the second pressing portion, the second pressing portion of the second position-limiting member is pressed against and matched with the battery cell, the welding protrusion is the connecting portion, and the second position-limiting member is welded to the fixing member through the welding protrusion.

14. The battery apparatus according to claim 1, wherein an electrode terminal is provided on a side of the battery cell away from the first wall, and along the first direction, the position-limiting member is located on one side of the electrode terminal and is spaced apart from the electrode terminal.

15. The battery apparatus according to claim 1, wherein a first buffer member is arranged between the position-limiting member and the battery cell.

16. The battery apparatus according to claim 15, wherein the first buffer member is arranged as an insulating structure.

17. The battery apparatus according to claim 15, wherein the battery cell comprises a case and an electrode terminal, an end of the case away from the first wall is a first end portion, the electrode terminal is located at the first end portion, the position-limiting member is pressed against the first end portion, the first buffer member comprises a first part and a second part, the first part is arranged between the position-limiting member and the electrode terminal, and the second part is arranged between the position-limiting member and the first end portion.

18. The battery apparatus according to claim 1, wherein a second buffer member is arranged between the fixing member and the battery cell.

19. The battery apparatus according to claim 18, wherein the second buffer member comprises a first sub-buffer member, the first sub-buffer member is arranged between an end of the fixing member facing the position-limiting member and the battery cell, a first buffer member is arranged between the position-limiting member and the battery cell, and the first buffer member and the first sub-buffer member are of an integral structure.

20. An electrical device, comprising the battery apparatus according to claim 1, the battery apparatus being used for storing electric energy or providing electric energy.
